(19) United States
(12) Patent Application Publication
(10) Pub. No.: US 2020/0170336 A1
(43) Pub. Date: Jun. 4, 2020

(54) THREE LAYER SHOE CONSTRUCTION WITH IMPROVED CUSHIONING, FLEXIBILITY AND TRACTION

(71) Applicant: Footwear Unlimited Inc., Fenton, MO (US)

(72) Inventor: Fabio Lucca, Valley Park, MO (US)

(21) Appl. No.: 16/205,301

(22) Filed: Nov. 30, 2018

(51) Int. Cl. A43B 13/12; A43B 13/04; A43B 17/14; A43B 13/16; A43B 7/00; A43B 13/18; A43B 7/14; A43B 1/00; A43B 7/32; B32B 3/30; B32B 25/04; B32B 25/14

(52) U.S. Cl. CPC A43B 13/122; B32B 2307/72; A43B 13/125; A43B 17/14; A43B 13/16; A43B 7/00; A43B 13/186; A43B 7/142; A43B 7/143; A43B 1/0045; A43B 7/32; B32B 3/30; B32B 25/045; B32B 25/14; B32B 2250/03; B32B 2266/025; B32B 2437/02; A43B 13/04

(57) ABSTRACT

A shoe construction having an outsole wherein the exterior face includes a forefoot section, a midfoot section, and a heel foot section, the forefoot and midfoot sections including a stair step pattern, the heel foot section including a plurality of projections, the interior face of the outsole including a forefoot cavity having a plurality of wavy rib members and a hind foot cavity having a plurality of straight rib members, a dual density midsole having a first density in the forefoot area and a second density in the hind foot area, and an insole receivable within the midsole and having a top face which includes a scored geometric pattern forming a plurality of non-linear grooves and projections some of which spiral outwardly from around the arch area and some of which extend into the forefoot and hind foot areas, and a pair of cushioning members receivable respectively within the forefoot and hind foot cavities of the outsole.

### FIELD OF THE INVENTION

The present invention relates to a shoe construction and, more particularly, to a three layered shoe construction with an outsole having a unique scored and stair-step type pattern on its exterior face and carved out sections on its interior face to enhance traction, flexibility, comfort and to reduce weight, a dual density midsole with cavities to allow for additional flexibility, and an insole having a novel scored pattern for increased breathability and flexibility coupled with a raised arch area for providing additional support to the arch of the foot.

### BACKGROUND OF THE INVENTION

Numerous shoes, covering a broad range of different designs and styles have been manufactured and sold in the marketplace. While shoes are worn to provide protection to one's feet, to reduce the impact felt when walking on hard surfaces, to provide support for the feet, and to prevent pronation, shoe designers must still seek to provide optimum levels of stability and comfort. In order to accomplish all of these objectives, shoe designers have used a wide variety of different tools and methods including heel plugs, shanks, contoured soles, deformable pillars or columns, spring-like structures, different traction designs, cushioning members, different shank designs, different ventilation structures, rocker elements, pads, gels and sole constructions having a plurality of different layers. Although these methods can be effective, the large number of components can result in increased manufacturing costs and complexity. It is therefore desirable to improve cushioning, flexibility, support and stability without increasing the number of components to achieve the same level of comfort for the user.

### SUMMARY OF THE INVENTION

The present invention is directed to a three layer shoe construction which includes an outsole, midsole, and insole, and a pair of cushioning insets receivable within the outsole. The three layers have a mating relationship which will be later described in detail. The three components of the present shoe are preferably secured together through conventional means such as through cementing and/or adhesives thereby preventing relative movement between the layers during assembly and use of the present shoe. Each of the three layers of the present shoe are generally in the shape of a human foot and can be divided into different sections according to the three different regions of the human foot—the forefoot, the midfoot, and the hind foot. The forefoot is generally adjacent to and includes the toe area, the hind foot is generally adjacent to and also includes the heel area; and the midfoot is located adjacent to both the forefoot and the hind foot. The ball of the foot is generally the area of the foot at the juncture between the metatarsal bones and the phalange bones. The two primary regions of the foot for load bearing when walking or standing normally are the ball area and the heel area, and the major bending of the shoe during normal use is typically in the ball area. The arch or instep is positioned between the heel and ball areas, and flexes very little when walking normally.

The present outsole is made out of a super lightweight thermoplastic rubber (TPR) and includes an exterior and interior face. The exterior face of the present outsole engages the ground or other walking surfaces, while the interior face is located opposite the exterior face and has a mating relationship with the midsole as will be hereinafter further described in more detail.

The exterior face of the present outsole includes a first section, a second section, and a third section, the first and second sections including a stair step type design forming a plurality of horizontal flat surfaces at the forefoot and midfoot areas of the outsole respectively, whereas the third section includes a plurality of scored projections forming ridges with corresponding grooves therebetween at the hind foot area. More specifically, each of the stair step type horizontal flat surfaces of the first section includes a scored pattern on the exterior face of the outsole with a groove between each flat surface for better traction and water displacement. Each of the stair step type surfaces of the second section includes a non-scored pattern with a groove between each flat surface for better traction and water displacement, and each of the projections of the third section includes a scored pattern as well. In other words, the plurality of grooves associated with each of the first, second and third sections promotes better traction and water displacement while the scored pattern on the first and third sections further promotes improved traction and improved water displacement. The specific stair step type surfaces, projections and plurality of grooves in each section of the exterior face of the outsole enhances traction while still providing for additional flexibility needed to allow the foot to roll through each step and push off normally while walking or running.

The interior face of the present outsole has a cavity located both at the forefoot and hind foot areas for receiving a cushioning pad respectively therewithin. The forefoot cavity on the interior face of the outsole has a plurality of horizontal wave-like protrusions associated therewith, some of which cut into the sidewall of the outsole. The protrusions or ribs give some strength to the forefoot area of the outsole while also providing a recess for keeping one of the cushioning pads from slipping or moving in the outsole. The cuts into the outsole sidewall in the forefoot area also provide more flexibility where a user's foot would normally flex. The hind foot cavity includes a plurality of substantially straight protrusions or ribs therewithin and one longitudinally extending rib which likewise provide some strength to the hind foot area of the outsole and which likewise also provides a recess for keeping another cushioning pad from moving or slipping within the cavity. The center on midfoot section of the interior face of the outsole likewise includes a plurality of substantially straight protrusions or ribs and one longitudinally extending rib, these ribs extending higher than the ribs associated with the forefoot and hind foot sections to provide better support to the midfoot area and arch area of a user's foot while still including hollow spaces or cavities to reduce weight. The plurality of wave-like and straight protrusions allow for additional flexibility and shock absorption in the outsole and the wave-like protrusions also diffuse weight across the ball of the foot. The cavities or recesses in the forefoot and hind foot areas also help to reduce weight.

The present midsole is made of a dual density blown ethylene-vinyl acetate copolymer (EVA) with an intrinsic molded arch support which supports the arch of the foot. The EVA creates a lightweight and resilient midsole which helps dissipate shock when walking or running. In addition to the material itself, the dual density of the midsole allows for greater flexibility and cushioning in the forefoot area due to its lighter density, and provides greater support and stability in the hind foot area due to its heavier density.

The midsole has an upper and a lower face. The upper face has a lip around the entire circumference of the midsole thereby creating a cavity on the upper face which is substantially in the shape of the insole while its lower face is substantially planar and is shaped to be received by the interior face of the outsole. The outsole has a mating relationship with the midsole wherein the lower face of the midsole mates with and is received by the interior face of the outsole. Similarly, the insole also has a mating relationship to the midsole wherein the insole mates with and is received by the cavity created by the lip on the upper face of the midsole. The three layers are preferably secured together in a conventional manner to prevent movement when worn. The lower face of the midsole includes a plurality of openings and ridges to allow for additional flexibility and to further reduce weight.

The present insole is made of a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole has a top face and a bottom face, wherein the top face engages with the foot of a wearer and has a unique scored pattern that provides both a cushioning effect and greater breathability when the present shoe is worn. In one embodiment, the scored pattern includes a plurality of non-linear grooves covering the entire top face of the insole forming a plurality of non-linear raised projections. This non-linear geometric pattern spirals outwardly around the arch area and extends substantially in a horizontal direction across the heel and forefoot areas. This non-linear pattern is also raised in the arch area to fit the supportive midsole arch design thereby providing comfort, breathability and additional flexibility.

The present three layer shoe construction absorbs shock, enhances comfort, and creates a unique propulsion effect, without requiring a vast number of components.

### BRIEF DESCRIPTION OF THE DRAWINGS

For a better understanding of the various embodiments of the present invention, reference may be made to the accompanying drawings in which:

FIG. 1 is an exploded perspective view illustrating a shoe structure constructed according to the teachings of the present invention;

FIG. 2 is a side elevational view of the outsole of FIG. 1;

FIG. 3 is a top plan view of the outsole of FIGS. 1 and 2;

FIG. 4 is a bottom plan view of the outsole of FIGS. 1, 2, and 3;

FIG. 5 is a side elevational view of the midsole of FIG. 1;

FIG. 6 is bottom plan view of the midsole of FIGS. 1 and 5;

FIG. 7 is a top plan view of the midsole of FIGS. 1 and 5 and 6;

FIG. 8 is side elevational view of the outsole and midsole of FIGS. 1-7;

FIG. 9 is a side elevational view of the insole of FIG. 1;

FIG. 10 is a top plan view of the insole of FIGS. 1 and 9;

FIG. 11 is a bottom plan view of the insole of FIGS. 1, 9 and 10;

FIG. 12 is a top plan view of the outsole, midsole and insole of FIGS. 1-11 mated together;

FIG. 13 is a cross-sectional view of the outsole, midsole, insole and cushioning pads mated together taken along lines 13-13 of FIG. 12.

While the disclosure is susceptible to various modifications and alternative forms, specific embodiments thereof are shown by way of example in the drawings and will hereinafter be described in detail. It should be understood, however, that the drawings and detailed description presented herein are not intended to limit the disclosure of the present invention to the particular embodiment disclosed, but on the contrary, the intention is to cover all modifications, equivalents, and alternatives falling within the spirit and scope of the present disclosure.

### DETAILED DESCRIPTION OF THE DRAWINGS

The present invention will now be described with reference to the drawing figures in which like reference numerals refer to like parts throughout the disclosure. For purposes of clarity in illustrating the characteristics of the present invention, proportional relationships of the elements have not necessarily been maintained in the drawing figures.

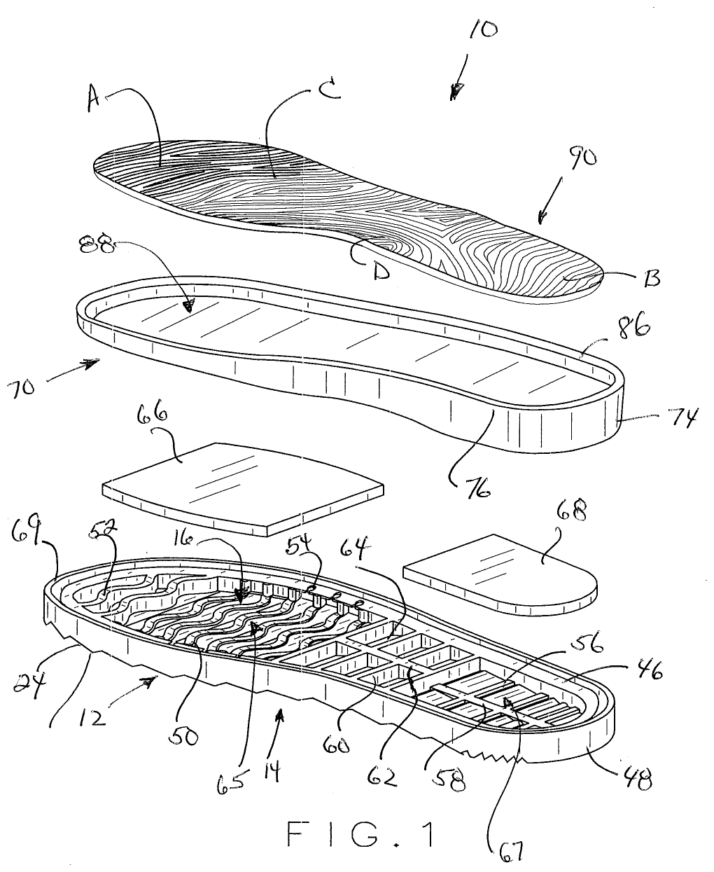

As illustrated in FIG. 1, a three layer shoe construction 10 constructed in accordance with the teachings of the present invention includes an outsole 12, a midsole 70, an insole 90, and a pair of cushioning pads 66 and 68. The outsole 12, midsole 70, and insole 90 have a mating relationship to each other as will be hereinafter further described and the cushioning pads 66 and 68 mate with cavities 42 and 44 in the outsole as will also be hereinafter further explained. The combination of the three layers and the cushioning pads provides a unique cushioning and energizing propulsion effect, giving the wearer a sense of bouncing off of the ground. The layers of the present shoe are preferably secured together in a conventional manner such as through cementing and/or adhesives thereby preventing relative movement between the layers during assembly and use of the present shoe.

Each of the three layers of the present shoe are generally in the shape of a human foot and can be divided into different sections according to three distinct regions of the human foot—the forefoot, midfoot, and hind foot. The forefoot area or region of the foot is approximately adjacent to and includes the toe area A, while the hind foot area or region of the foot is approximately adjacent to and includes the heel area B. The midfoot area or region is approximately adjacent to both the forefoot and hind foot region as illustrated in FIG. 1 and includes the arch D. The ball area C of the foot is generally the area of the foot at the juncture between the metatarsal bones and the phalange bones. The two primary regions of the foot for load bearing when walking or standing normally includes the ball area C and the heel area B, and the major bending of the shoe during normal use is typically in the vicinity of the ball area C. The arch or instep area D is located between the heel area B and ball area C, and flexes very little when walking normally.

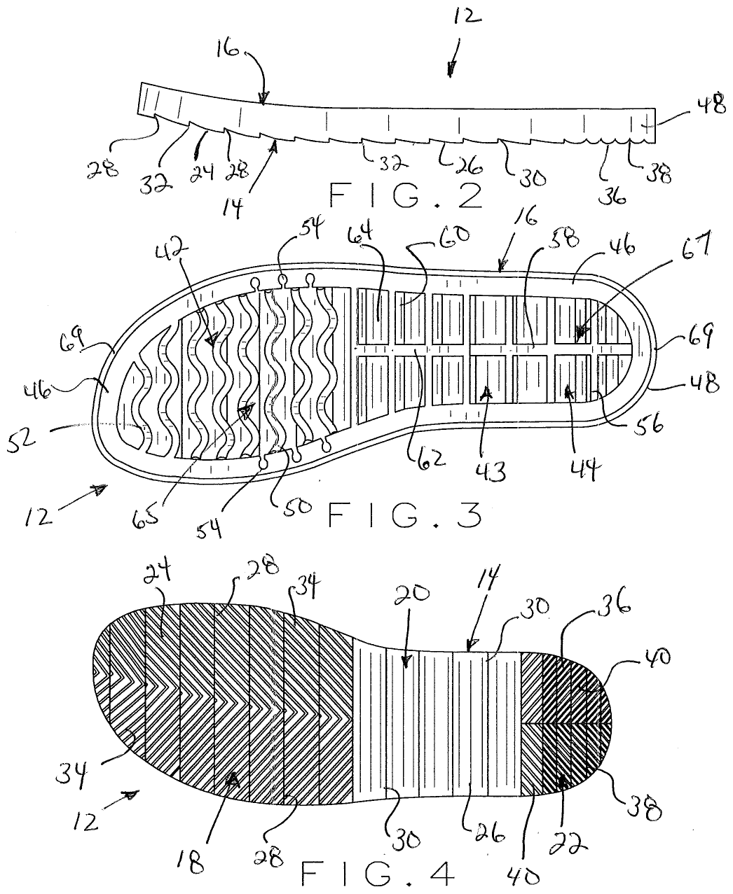

The present outsole 12 is made out of a super lightweight thermoplastic rubber (TPR) and has an exterior face 14 and an interior face 16 as seen in FIGS. 2-4. The exterior face 14 of the outsole 12 engages with the ground or other walking surfaces, while the interior face 16 has a mating relationship with the midsole 70 as will be hereinafter described in more detail.

In one embodiment, the exterior face 14 of the outsole 12 has a first section 18, a second section 20, and a third section 22, divided approximately into the forefoot, midfoot, and hind foot areas respectively as best illustrated in FIG. 3. The first section 18 and second section 20 each include a plurality of stair step type horizontal flat surfaces 24 and 26 respectively forming a plurality of generally horizontal grooves 28 in the first section 18 and a plurality of generally horizontal grooves 30 in the second section 20. The grooves 28 and 30 each lie respectively between adjacent stair step flat surfaces 24 and 26 as best illustrated in FIGS. 2 and 4. The grooves 28 and 30 form a plurality of angled ridges or projections 32 with a corresponding flat surface 24 or 26 that form a traction pattern as illustrated. The corresponding ridges 32 improve traction and the corresponding grooves 28 and 30 improve water displacement. Each of the stair step type surfaces 24 in the first section 18 also include a scored pattern forming a plurality of angled grooves 34 (FIG. 4) which further contribute to better water displacement. Each of the stair step type surfaces 26 in the second section 20 include a non-scored or smooth surface.

The third section 22 associated with the exterior face 16 of the outsole 12 includes a plurality of scored projections 36 as best illustrated in FIGS. 2 and 4, the projections 36 forming ridges with corresponding grooves 38 positioned therebetween in the hind foot area. Each of the projections 36 includes a similar scored pattern as associated with the first section 18, the scored pattern associated with the third section 22 likewise forming a plurality of grooves 40 which again further contribute to better water displacement. Each of the projections 36 are semi-circular in shape as illustrated in FIG. 2, thereby allowing water to easily pass through the respective grooves 38 and through the respective scored grooves 40 to again further improve water displacement. The specific stair step flat surfaces 24 and 26 associated with the first and second sections of the exterior face of the present outsole 12 along with the projections 36 and the plurality of grooves 28, 30, and 38 as well as the plurality of scored grooves 34 and 40 in each of the sections associated with the exterior face of the outsole 12 enhances not only traction but also water displacement while still providing for additional flexibility as will be addressed with respect to the interior face 16 of the outsole 12. The scored grooves 34 and 40 associated with the first and third sections 18 and 22 of outsole 12 cover substantially the entire forefoot and hind foot sections of the outsole.

Turning to FIG. 3, the interior face 16 of outsole 12 includes a cavity 42 located in a first section or forefoot area and a cavity 44 located in a second section or hind foot area as best illustrated in FIGS. 1 and 3, the cavities 42 and 44 being housed within a ledge or lip 46 which extends around the entire circumference of the outsole 12 and forms part of the sidewall 48. The forefoot cavity 42 includes a plurality of horizontal wave-like projections or protrusions 50 which cover a majority of the forefoot area and cavity 42 likewise includes a pair of substantially horizontal wave-like projections 52 located in the toe area of the outsole 12. The protrusions or ribs 52 have a greater height or depth as compared to the projections or ribs 50 and the ribs 52 extend so as to be flush with the lip or ledge 46. In addition, some of the plurality of protrusions or ribs 50 cut or extend into the sidewall or ledge or lip portion 46 as best illustrated in FIGS. 1 and 3 such as at locations 54. The protrusions or ribs 50 and 52 give some strength to the forefoot area of the outsole 12 but also provide flexibility in the forefoot area due to the fact that the cavity 42 is carved out of the material forming the outsole 12. In addition, the cutout portions 54 likewise enhance flexibility as they cut into the ledge 46 and sidewall 48 of the forefoot area. The cuts 54 in the sidewall 46/48 of the outsole 12 also provide more flexibility where a user's foot would normally flex during walking.

The hind foot cavity 44 includes a plurality of substantially straight protrusions or ribs 56 and one longitudinally extending rib 58 as best illustrated in FIGS. 1 and 3. The protrusions or ribs 56 and 58 likewise provide some strength to the hind foot area of the outsole 12. The center or midfoot section 43 of the interior face 16 likewise includes a plurality of substantially straight protrusions or ribs 60 and one longitudinally extending rib 62 as again best illustrated in FIGS. 1 and 3. The protrusions or ribs 60 and 62 extend higher than the ribs or protrusions 50, 56 and 58 as best illustrated in FIG. 1 and the height or depth of the protrusions or ribs 60 and 62 are such that they lie substantially flush with the circumferential lip 46 as again best illustrated in FIG. 1. This center section 43 provides better support to the midfoot area and arch area of a user's foot while still including a plurality of hollow spaces or cavities 64 to reduce weight. The wave-like projections 52 and the straight projections 60 and 62 protrude height wise to the same height as the outsole lip 46 and allow for additional flexibility and shock absorption in the outsole. The plurality of wave-like protrusions 50 also diffuse weight across the ball area C of the foot and extend to a height which is less than the protrusions or ribs 52 and 60.

The area 65 above the protrusions 50 forms a space or cavity for receiving a cushioning pad 66 which is sized and shaped to be positioned within the space or area 65 as best illustrated in FIG. 1. The space 65 is bound by one of the ribs 52, one of the ribs 60, and a portion of the sidewall lip or ledge 46 as best illustrated in FIG. 1. Cushioning pad 66 can be made of any cushioning type material including foam, a lightweight blown EVA material, or any other similar or suitable material. The cushioning pad 66 rests upon the ribs or protrusions 50 and protrudes or extends to the same height as the lip portion 46 of the outsole 12. This again allows for still additional cushioning and shock absorption in the outsole. The same is likewise true with respect to the hind foot cavity 44 where the protrusions or ribs 56 and 58 protrude to a height which is less than the height of the ribs 60 and 62 associated with the center or midfoot section 43 thereby forming a space or cavity 67 above the ribs 56 and 58 for receiving a second cushioning member 68 as again best illustrated in FIG. 1. Here again, the cushioning pad 68 rests upon the ribs or protrusions 56 and 58 and extends to a height so as to be substantially flush with the lip or ledge 46 of the outsole 12. Cushioning pad 68 likewise provides for additional cushioning and shock absorption in the heel area and can be made of the same material as cushioning pad 66. The cavities and recesses 42, 44, 64, 65 and 67 throughout the interior face 16 of the outsole 12 also helps to reduce weight and increase flexibility.

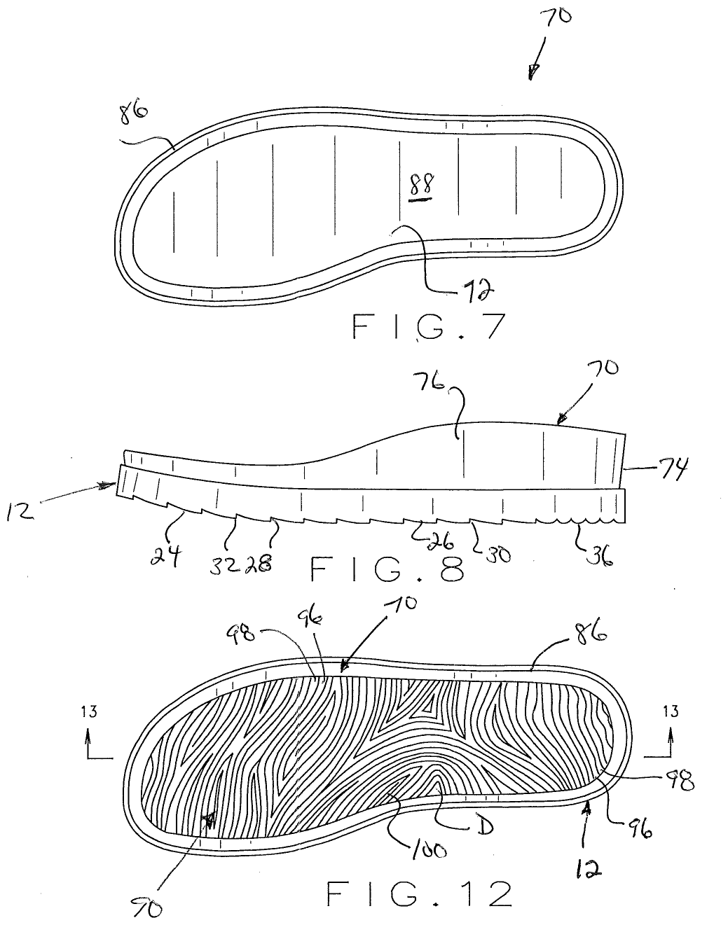

As shown in FIGS. 5-8, the midsole 70 is made of a dual density blown ethylene-vinyl acetate copolymer (EVA) with an intrinsic molded arch support 72. The raised arch area of the intrinsic molded arch support 72 provides additional support for the arch D of the foot. The EVA creates a lightweight and resilient midsole 70, which helps dissipate shocks when walking or running. In addition to the material itself, the dual density of the midsole 70 allows for greater flexibility and cushioning in the forefoot area due to its lighter density and, at the same time, provides greater support and stability in the hind foot area due to its heavier density. In simple terms, the forefoot area of the present midsole 70 has a lighter density as compared to a heavier density heel area.

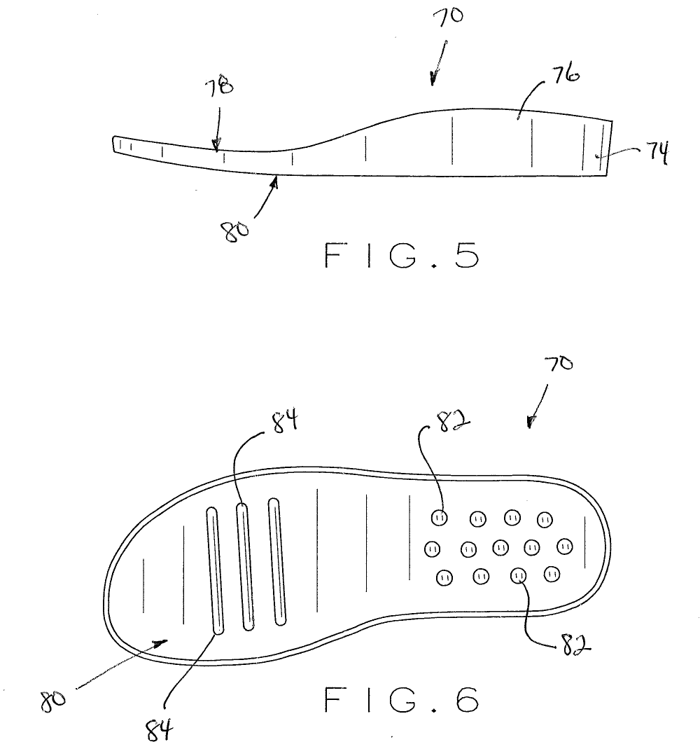

The sidewall 74 of the midsole 70 includes a raised area 76 which extends completely around the heel area and tapers into the midfoot and forefoot areas as illustrated in FIGS. 1 and 5. This provides great support and cushioning in the heel area of a user's foot. The midsole 70 has both an upper face 78 and a lower face 80 as best seen in FIG. 5. Turning to FIG. 6, the lower face 80 is sized and shaped to be inserted into and received by the interior face 16 of the outsole 12, the lower face 80 fitting into the space of the outsole by and between the cushioning pads 66 and 68, the top surface of the ribs 52, 60 and 62, and the top edge portion 69 of the outsole 12. The outsole 12 has a mating relationship with the midsole 70 wherein the midsole 70 mates with and is received by the outsole 12 as explained above and as shown in FIGS. 1 and 8. The lower face 80 also includes a plurality of bores or cavities 82 which are located and positioned in the heel area and extend into a portion of the midfoot area to increase flexibility and cushioning, and to reduce weight. The lower face 80 likewise includes a plurality of linear ribs or protrusions 84 in the forefoot area to also improve cushioning and flexibility in the forefoot area of a user. The ribs 84 also help to prevent any shifting or movement of the midsole relative to the outsole.

Substantially similar to the lower face 80, the upper face 78 of midsole 70 also includes a lip 86 around the entire circumference of the midsole 70 thereby creating a cavity 88 as best seen in FIG. 1. The cavity 88 is generally in the shape of insole 90 and is likewise dimensioned to mate with and receive the insole 90 as best illustrated in FIGS. 1, 12 and 13.

FIG. 8 is a side elevational view of the outsole 12 mated with the midsole 70.

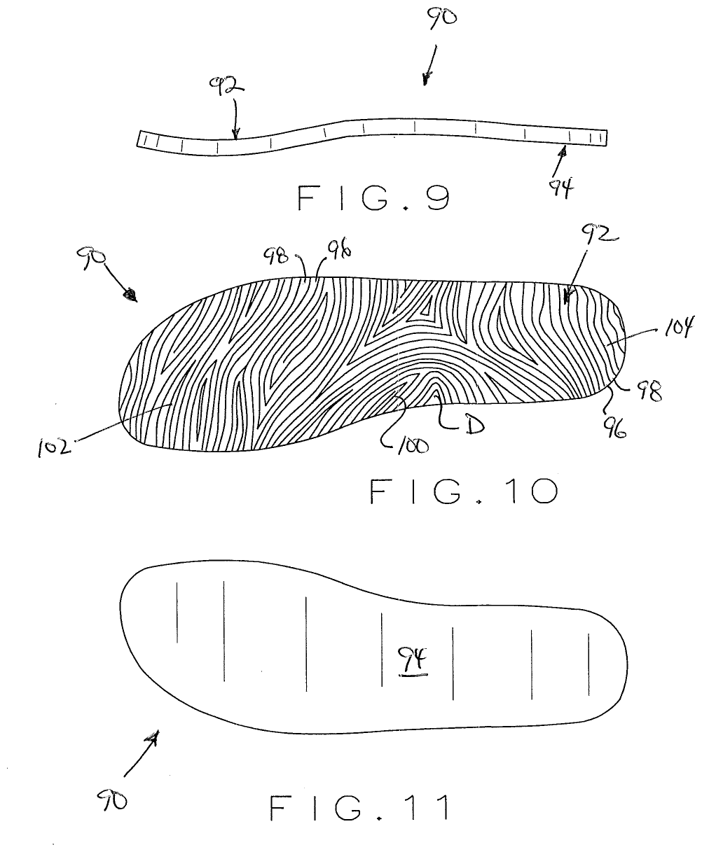

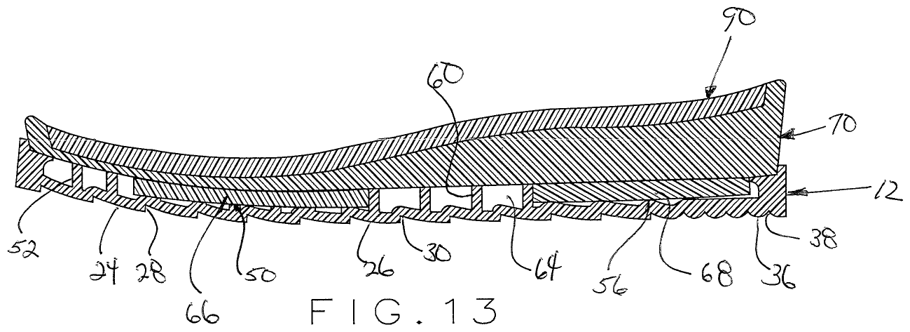

As illustrated in FIGS. 9-12, the insole 90 is made of a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole 90 has a top face 92 and a bottom face 94, wherein the top face 92 engages with the foot of a wearer and includes a unique scored pattern as best illustrated in FIGS. 11 and 12 that extends over the entire top face 92 and provides a cushioning effect and greater breathability when the shoe is worn. The scored pattern includes a plurality of non-linear grooves 96 covering the entire top face 92 forming a plurality of non-linear raised projections 98. Portion 100 of the non-linear geometric pattern spirals outwardly from around the arch area D and other portions 102 and 104 extend generally in a somewhat horizontal direction across the forefoot and heel area respectively as illustrated in FIGS. 10 and 12. This non-linear pattern is also raised in the arch area D to fit the supportive midsole 70 arch design thereby further providing comfort, breathability and flexibility. Finally, unlike the top face 92 of the insole 90, the bottom face 94 is substantially smooth as illustrated in FIG. 11. The combination of the outsole 12, midsole 70, insole 90 and cushioning pads 66 and 68 as illustrated in FIG. 13 allows for great shock absorption, cushioning, flexibility and also produce a unique energizing propulsion effect.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A shoe construction comprising:
an outsole having an exterior face, an interior face, a forefoot area, a midfoot area and a hind foot area, the exterior face including a first section located in the vicinity of the forefoot area, a second section located in the vicinity of the midfoot area, and a third section located in the vicinity of the hind foot area, each of said first and second sections including a stair step pattern forming a plurality of horizontal flat surfaces with corresponding grooves positioned therebetween, the first section further including a scored pattern associated with each of said horizontal flat surfaces, and the third section including a plurality of projections forming ridges with corresponding grooves positioned therebetween, the third section further including a scored pattern associated with each of said ridges, the interior face including spaced apart first and second cavities;
a midsole having an upper face, a lower face, a forefoot area and a hind foot area, the midsole having a first density in the forefoot area and a second density in the hind foot area, the midsole having a cavity located and positioned on its upper face;
an insole having a top face, a bottom face, a forefoot area, a midfoot area, an arch area, and a heel area, the top face of the insole including a scored pattern forming a plurality of non-linear grooves and projections; and
a pair of pad members, one pad member being received within the first cavity associated with the interior face of said outsole and the other pad member being received within the second cavity associated with the interior face of said outsole;
the interior face of the outsole further receiving the exterior face of the midsole;
the cavity positioned and located on the upper face of said midsole being shaped and dimensioned to receive the insole.

2. The shoe construction of claim 1 wherein the first cavity associated with the interior face of said outsole includes a plurality of horizontal wave-like projections and the second cavity associated with the interior face of said outsole includes a plurality of straight projections.

3. The shoe construction of claim 2 wherein one of the pad members rests on the horizontal wave-like projections of the first cavity of said outsole and the other pad member rests on the straight projections of the second cavity of said outsole.

4. The shoe construction of claim 2 wherein at least some of the horizontal wave-like projections associated with the first cavity of said outsole cuts into a sidewall of the outsole.

5. The shoe construction of claim 2 wherein the first and second cavities of said outsole are separated by a center portion having a plurality of straight projections.

6. The shoe construction of claim 1 wherein the lower face of the midsole includes a plurality of bores in the heel area.

7. The shoe construction of claim 1 wherein the lower face of the midsole includes a plurality of linear rib members in the forefoot area.

8. The shoe construction of claim 1 wherein some of the plurality of non-linear grooves and projections associated with the top face of the insole spiral outwardly from around the arch area, and some of the non-linear grooves and projections associated with the top face of the insole extend in a generally horizontal direction in the forefoot area and heel foot area.

9. The shoe construction of claim 1 wherein the grooves separating the horizontal flat surfaces of the first and second sections of the exterior face of the outsole each form an angled projection with its corresponding flat surface.

10. The shoe construction of clam 1 wherein the outsole is made of a super lightweight thermoplastic rubber (TPR).

11. The shoe construction of claim 1 wherein the midsole is made of a dual density ethylene-vinyl acetate copolymer (EVA).

12. The shoe construction of claim 1 wherein the insole is made of a lightweight thermal molded EVA.

13. The shoe construction of claim 1 wherein each scored pattern of said first and third sections forming a plurality of angled grooves.

14. A shoe construction comprising:
an outsole having an exterior face, an interior face, a forefoot area, a midfoot area and a hind foot area, the exterior face including a first section located in the vicinity of the forefoot area, a second section located in the vicinity of the midfoot area, and a third section located in the vicinity of the hind foot area, each of said first and second sections including a stair step pattern forming a plurality of horizontal flat surfaces separated by a groove respectively therebetween, the first section further including a scored pattern associated with each of said horizontal flat surfaces, each scored pattern of said first section forming a plurality of angled grooves, and the third section including a plurality of projections forming ridges with corresponding grooves positioned therebetween, the third section further including a scored pattern associated with each of said ridges, each scored pattern of said third section forming a plurality of angled grooves;
the interior face of said outsole including a forefoot cavity and a hind foot cavity, the forefoot cavity including a plurality of horizontal wave-like rib members and the hind foot cavity including a plurality of straight rib members, and a lip portion extending around the circumference of said outsole;
a midsole having an upper face, a lower face, a forefoot area and a hind foot area, the midsole having a first density in the forefoot area and a second density in the hind foot area, the midsole having a cavity located and positioned on its upper face;
an insole having a top face, a bottom face, a forefoot area, a midfoot area, an arch area, and a heel area, the top face of the insole including a scored geometric pattern forming a plurality of non-linear grooves and projections, some of said non-linear grooves and projections spiraling outwardly from around the arch area and some of said non-linear grooves and projections extending in a generally horizontal direction in the forefoot and heel areas; and
a pair of cushioning members, one cushioning member being received within the forefoot cavity of the outsole and the other cushioning member being received within the hind foot cavity of the outsole;
the interior face of the outsole further receiving the exterior face of the midsole;
the cavity located and positioned on the upper face of the midsole being shaped and dimensioned to receive the insole.

15. The shoe construction of claim 14 wherein at least some of the horizontal wave-like projections associated with the forefoot cavity of the outsole extend into the lip portion of the outsole.

16. The shoe construction of claim 14 including a center section located between the forefoot cavity and the hind foot cavity associated with the interior face of the outsole, said center section including a plurality of straight rib members, the straight rib members associated with said center section being taller than the rib members associated with the hind foot cavity and being taller than at least some of the wave-like rib members associated with the forefoot cavity.

17. The shoe construction of claim 14 wherein one of said cushioning members receivable within the forefoot cavity of said outsole rests upon at least some of the horizontal wave-like rib members associated therewith and the other cushioning member receivable within the hind foot cavity of said outsole rests upon at least some of the plurality straight rib members associated therewith.

18. A shoe construction comprising:
an outsole having an exterior face, an interior face, a forefoot area, a midfoot area and a hind foot area, the exterior face including a first section located in the vicinity of the forefoot area, a second section located in the vicinity of the midfoot area, and a third section located in the vicinity of the hind foot area, each of said first and second sections including a stair step pattern forming a plurality of horizontal flat surfaces with corresponding grooves positioned therebetween, said first section further including a scored pattern associated with each of said horizontal flat surfaces, each scored pattern of said first section forming a plurality of angled grooves, the third section including a plurality of projections forming ridges with corresponding grooves positioned therebetween, said third section further including a scored pattern associated with each of said ridges, each scored pattern of said third section forming a plurality of angled grooves;
the interior face of said outsole including a forefoot section, a midfoot section and a heel foot section, said forefoot section including a cavity having a plurality of horizontal wavy rib members associated therewith, at least some of said wavy rib members extending into a sidewall of the outsole, said midfoot section and said heel foot section each including a plurality of horizontal extending straight rib members and at least one longitudinally extending straight rib member, the rib members associated with the midfoot section being taller than at least some of the rib members associated with the forefoot section and the heel foot section;
a midsole having an upper face, a lower face, a forefoot area and a hind foot area, the midsole having a first density in the forefoot area and a second density in the hind foot area, the upper face of the midsole includes the lip portion extending around the circumference of the midsole thereby creating a cavity therebetween, the bottom face of the midsole including a plurality of cavities located in the heel foot area and a plurality of linear rib members located in the forefoot area;
an insole having a top face, a bottom face, a forefoot area, a midfoot area, an arch area, and a heel area, the top face of the midsole including a scored geometric pattern forming a plurality of non-linear grooves and projections, some of said non-linear grooves and projections spiraling outwardly from around the arch area and some of said non-linear grooves and projections extending in a generally horizontal direction in the forefoot and hind foot areas; and
a pair of cushioning pad members, one of said cushioning pad members being received within the forefoot cavity associated with the interior face of the outsole, said one cushioning pad member resting upon at least some of said horizontal wavy rib members, and the other cushioning pad member being received within the hind foot cavity associated with the interior face of said outsole, said other cushioning pad member resting upon at least some of the plurality of straight rib members;
the interior face of said outsole further receiving the exterior face of said midsole, at least a portion of the exterior face of said midsole resting upon said pair of cushioning pad members;
the cavity associated with the top face of said midsole being shaped and dimensioned to receive the bottom face of said insole.

19. The shoe construction of claim 18 wherein the outsole is made of a super light-weight thermoplastic rubber (TPR).

20. The shoe construction of claim 18 wherein the midsole is made of a dual density ethylene-vinyl acetate copolymer (EVA).

21. The shoe construction of claim 18 wherein the insole is made of a lightweight thermal molded EVA.

22. The shoe construction of claim 18 wherein the insole includes an antimicrobial shield.
